(19) United States
(12) Patent Application Publication
(10) Pub. No.: US 2018/0046143 A1
(43) Pub. Date: Feb. 15, 2018

(54) QUICK MULTIFUNCTIONAL SMART WATCH FOR WORSHIP TIMING AND ORIENTATION AND CONTROL METHOD

(71) Applicant: Xian Gaotai Electronic Technology Co., Ltd., Xian (CN)

(72) Inventors: Renyi Gu, Shanghai (CN); Zhaoyu Huang, Xian (CN); Dapeng Lin, Xian (CN)

(21) Appl. No.: 15/410,462

(22) Filed: Jan. 19, 2017

(30) Foreign Application Priority Data
Aug. 9, 2016 (CN) 201610647249.0

(51) Int. Cl. G04B 47/06; G04G 13/02

(52) U.S. Cl. CPC G04B 47/065; G04G 13/026

(57) ABSTRACT

Disclosed is a quick multifunctional smart watch for worship timing and orientation and a control method, relating to the technical field of smart watches, for solving the problem that no portable wearable products for orientated and timed reminding meet requirements of Moslems for worships in the prior art. The watch comprises a controller, a positioning module, a geomagnetic sensor and pointer devices; the positioning module is used for acquiring position information of current position and sending to the controller; the geomagnetic sensor is used for acquiring direction information of current position and sending to the controller; the controller is used for controlling pointer devices to point to the direction of Mecca according to pre-stored position information of Mecca, position information and direction information of current position and GIS geographic information pre-stored in the controller; and the controller is also used for reminding worships according to pre-stored preset worship time.

### FIELD OF THE INVENTION

The present invention relates to the technical field of smart watches, and more specifically, relates to a quick multifunctional smart watch for worship timing and orientation and a control method.

### BACKGROUND OF THE INVENTION

Islam is one of the three major world-famous religions. Nowadays, about 900 million people in the world believe in Islam according to statistics, accounting for 18.5% of the world's total population, and they are mainly distributed in North Africa, Western Asia, South Asia, Southeast Asia, etc. Moslems of varying quantities are nearly distributed worldwide except a few countries. At present, people in about 28 countries almost believe in Islam, Moslems in 35 countries account for over 50%, and more than twenty countries among the 63 countries are Arab countries. Islamic etiquette requires five daily worships, one weekly worship (i.e., Sunnah Jumah worship) and two annual festival worships (i.e., worships of Corban Festival and Lesser Bairam). The days from December 8 to 10 of Islamic calendar are statutory hajj dates (i.e., principal hajj). Visiting Mecca Kaaba beyond the dates is referred to as “UMRAH” (i.e., “secondary hajj”). The so-called “hajj” is generally referred to as “principal hajj”. It is compulsory for healthy Moslems having enough money to visit Mecca once in life under the condition of a safe trip.

At present, outgoing, going abroad, going for business, traveling and outdoor activities are increasingly frequent with continuous development of science and technology, continuous development of people's living standard and more economic and trade activities. People believing in Islam carry out five worships towards Mecca Kaaba every day no matter where they are with the respect for the canon and the etiquette. However, no relevant portable wearable products for orientated and timed reminding in the market can meet the requirements of people believing in Islam. In conclusion, the prior art has the problem that no relevant portable wearable products for orientated and timed reminding meet the requirements of people believing in Islam for worships.

### SUMMARY OF THE INVENTION

The embodiments of the present invention provide a quick multifunctional smart watch for worship timing and orientation and a control method for solving the problem that no portable wearable products for orientated and timed reminding meet the requirements of people believing in Islam for worships in the prior art.

The embodiments of the present invention provide a quick multifunctional smart watch for worship timing and orientation, including a controller, a positioning module, a geomagnetic sensor and pointer devices;

the positioning module is used for acquiring position information of a current position and sending the position information of the current position to the controller;

the geomagnetic sensor is used for acquiring direction information of the current position and sending the direction information of the current position to the controller;

the controller is used for controlling the pointer devices to point to the direction of Mecca according to the position information of Mecca pre-stored in a memory of the controller, the position information of the current position, the direction information of the current position and the GIS (Geographic Information System) geographic information pre-stored in the memory of the controller; and the controller is also used for reminding worships according to the preset worship time pre-stored in the memory of the controller.

Preferably, the watch further includes a gyro, which is used for correcting the direction information of the current position to obtain corrected direction information of the current position;

the controller is further used for determining a straight line between Mecca and the current position according to the position information of Mecca and the position information of the current position, determining the included angle between the straight line and the geographic axis, the included angle between the straight line and the geomagnetic axis and the included angle formed by the straight line and the corrected direction information of the current position according to the GIS geographic information, and controlling the pointer devices to point to the direction of Mecca according to the included angle between the straight line and the geographic axis, the included angle between the straight line and the geomagnetic axis and the included angle formed by the straight line and the corrected direction information of the current position;

the controller is further used for determining a straight line between Mecca and the current position according to the position information of Mecca and the position information of the current position, determining the included angle between the straight line and the geographic axis, the included angle between the straight line and the geomagnetic axis and the included angle formed by the straight line and the corrected direction information of the current position according to the GIS geographic information, and controlling the pointer devices to point to the direction of Mecca according to the included angle between the straight line and the geographic axis, the included angle between the straight line and the geomagnetic axis and the included angle formed by the straight line and the corrected direction information of the current position.

Preferably, the watch further includes a buzzer, which is connected with the controller and used for reminding worships according to the preset worship time pre-stored in the memory of the controller.

Preferably, the pointer devices include motors, gearboxes and pointers; the controller is electrically connected with the motors, and the motors are connected with the pointers via the gearboxes; the motors are step motors, and a plurality of motors are provided.

Preferably, the motors include a first motor, a second motor and a third motor; the gearboxes include a first gearbox, a second gearbox and a third gearbox; the pointers include a clock pointer, a compass pointer and a time zone pointer;

the controller is electrically connected with the first motor, the second motor and the third motor respectively;

the first motor is connected with the clock pointer via the first gearbox, the second motor is connected with the compass pointer via the second gearbox, and the third motor is connected with the time zone pointer via the third gearbox.

Preferably, the watch further includes a UTC (Universal Time Coordinated) module, a dual time zone functional module, an automatic/manual energy display module and a time precision error automatic compensation module, and the watch is further reserved with a Bluetooth interface, a temperature sensor interface and an infrared sensor interface.

Preferably, the watch further includes at least one key which is connected with the controller.

Preferably, the watch further includes a power supply and a power switch; both the power supply and the power switch are connected with the controller; and the power supply is connected with the positioning module, the geomagnetic sensor and the pointer devices via the power switch respectively.

Preferably, the watch further includes dial plates which includes a center dial plate and an auxiliary dial plate arranged on the center dial plate.

The embodiments of the present invention provide a control method for the quick multifunctional smart watch for worship timing and orientation, including the following steps:

acquiring position information of Mecca;

acquiring position information of the current position;

acquiring direction information of the current position;

acquiring GIS geographic information;

acquiring preset worship time;

determining the direction of Mecca via a positioning algorithm according to the position information of Mecca, the position information of the current position, the direction information of the current position and the GIS geographic information; and reminding of worships according to the preset worship time.

Preferably, the control method for the watch further includes: acquiring corrected direction information of the current position;

the step of determining the direction of Mecca via a positioning algorithm according to the position information of Mecca, the position information of the current position, the direction information of the current position and the GIS geographic information includes:

determining a straight line between Mecca and the current position according to the position information of Mecca and the position information of the current position; determining the included angle between the straight line and the geographic axis, the included angle between the straight line and the geomagnetic axis and the included angle formed by the straight line and the corrected direction information of the current position according to the GIS geographic information; and

determining the direction of the destination according to the included angle between the straight line and the geographic axis, the included angle between the straight line and the geomagnetic axis and the included angle formed by the straight line and the corrected direction information of the current position.

The embodiments of the present invention provide a quick multifunctional smart watch for worship timing and orientation and a control method, wherein the controller in the watch acquires position information of the current position via the positioning module, acquires direction information of the current position via the geomagnetic sensor and controls the pointer devices to point to the direction of Mecca (Kaaba) via the positioning algorithm according to the position information of Mecca (Kaaba) and the GIS geographic information, so that a worshipper acquires the worship direction simply, intuitively and clearly via the pointers before worships, and the worships are automatically reminded according to the preset worship time.

### BRIEF DESCRIPTION OF THE DRAWINGS

FIG. 1 is a principle block diagram of a quick multifunctional smart watch for worship timing and orientation provided by an embodiment of the present invention.

FIG. 2 is a structural diagram of a dial plate of the quick multifunctional smart watch for worship timing and orientation provided by an embodiment of the present invention.

FIG. 3 is a flow diagram of a control method for the quick multifunctional smart watch for worship timing and orientation provided by an embodiment of the present invention.

FIG. 4-1 is a circuit principle diagram of a controller of the quick multifunctional smart watch for worship timing and orientation provided by an embodiment of the present invention.

FIG. 4-2 is a circuit principle diagram of a positioning module of the quick multifunctional smart watch for worship timing and orientation provided by an embodiment of the present invention.

FIG. 4-3 is a circuit principle diagram of a geomagnetic sensor of the quick multifunctional smart watch for worship timing and orientation provided by an embodiment of the present invention.

FIG. 4-4 is a circuit principle diagram of motors of the quick multifunctional smart watch for worship timing and orientation provided by an embodiment of the present invention.

FIG. 4-5 is a circuit principle diagram of keys of the quick multifunctional smart watch for worship timing and orientation provided by an embodiment of the present invention.

FIG. 4-6 is a circuit principle diagram of a power supply of the quick multifunctional smart watch for worship timing and orientation provided by an embodiment of the present invention.

FIG. 4-7 is a circuit principle diagram of a power switch of the quick multifunctional smart watch for worship timing and orientation provided by an embodiment of the present invention.

FIG. 4-8 is a circuit principle diagram of a buzzer of the quick multifunctional smart watch for worship timing and orientation provided by an embodiment of the present invention.

In which:

101—controller, 102—positioning module, 103—geomagnetic sensor, 104—motor, 104-1—first motor, 104-2—second motor, 104-3—third motor, 105—gearbox, 105-1—first gearbox, 105-2—second gearbox, 105-3—third gearbox, 106—pointer, 106-1—clock pointer, 106-2—compass pointer, 106-3—time zone pointer, 107—key, 108—power supply, 109—power switch, 110—buzzer.

### DETAILED DESCRIPTION OF THE EMBODIMENTS

A clear and complete description of the technical solutions in the embodiments of the present invention will be given below, in combination with the accompanying drawings in the embodiments of the present invention. Apparently, the described embodiments are merely a part, but not all, of the embodiments of the present invention. All of the other embodiments, obtained by those of ordinary skill in the art based on the embodiments of the present invention without any inventive effort, fall into the protection scope of the present invention.

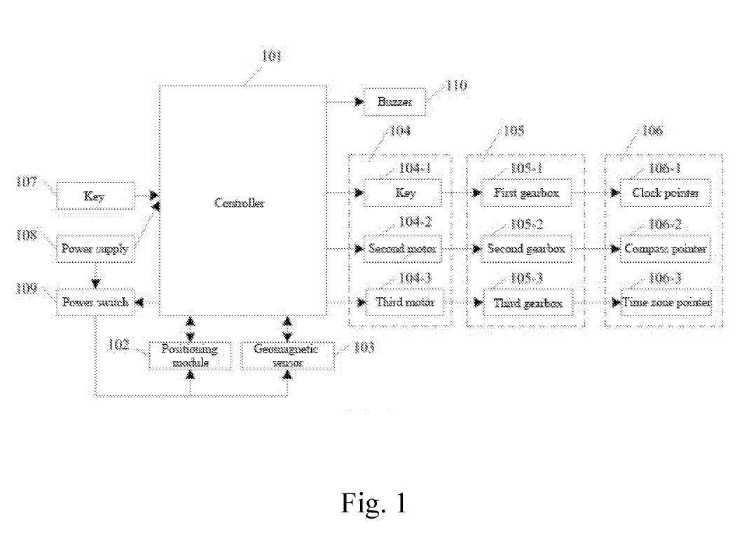

FIG. 1 exemplarily shows a principle block diagram of a quick multifunctional smart watch for worship timing and orientation provided by an embodiment of the present invention. As shown in FIG. 1, the quick multifunctional smart watch for worship timing and orientation provided by the embodiment of the present invention at least includes a controller 101, a positioning module 102, a geomagnetic sensor 103 and pointer devices.

Specifically, the positioning module 102 is used for acquiring position information of a current position and sending the position information of the current position to the controller 101; the geomagnetic sensor 103 is used for acquiring direction information of the current position and sending the direction information of the current position to the controller 101; the controller 101 is used for controlling the pointer devices to point to the direction of Mecca according to the position information of Mecca pre-stored in a memory of the controller 101, the position information of the current position, the direction information of the current position and the GIS geographic information pre-stored in the memory of the controller 101; and the controller 101 is also used for reminding of worships according to the preset worship time pre-stored in the memory of the controller 101.

Preferably, the quick multifunctional smart watch for worship timing and orientation further includes a gyro, which is used for correcting the direction information of the current position to obtain corrected direction information of the current position; the controller 101 is further used for determining a straight line between Mecca and the current position according to the position information of Mecca and the position information of the current position, determining the included angle between the straight line and the geographic axis, the included angle between the straight line and the geomagnetic axis and the included angle formed by the straight line and the corrected direction information of the current position according to the GIS geographic information, and controlling the pointer devices to point to the direction of Mecca according to the included angle between the straight line and the geographic axis, the included angle between the straight line and the geomagnetic axis and the included angle formed by the straight line and the corrected direction information of the current position.

It should be noted that the gyro is used for correcting and compensating orientated included angles on signal interference of the geomagnetic sensor 103 and variations of dynamic control of a user.

Preferably, the quick multifunctional smart watch for worship timing and orientation provided by the embodiment of the present invention further includes a buzzer 110, which is connected with the controller 101; and the controller 101 reminds of worships via the buzzer 110 according to the preset worship time pre-stored in the memory of the controller 101.

It should be noted that the pointer devices include motors 104, gearboxes 105 and pointers 106; the controller 101 is electrically connected with the motors 104, and the motors 104 are connected with the pointers 106 via the gearboxes 105; the motors 104 are step motors, and a plurality of motors 104 are provided.

The embodiment of the present invention provides three pointer devices as an example as follows:

the pointer devices include a clock pointer device, a compass pointer device and a time zone pointer device; the clock pointer device includes a first motor 104-1 electrically connected with the controller 101, and the first motor 104-1 is connected with a clock pointer 106-1 via a first gearbox 105-1; the compass pointer device includes a second motor 104-2 electrically connected with the controller 101, and the second motor 104-2 is connected with a compass pointer 106-2 via a second gearbox 105-2; the time zone pointer device includes a third motor 104-3 electrically connected with the controller 101, and the third motor 104-3 is connected with a time zone pointer 106-3 via a third gearbox 105-3.

It should be noted that the clock pointer device is used for displaying time information in real time via the clock pointer 106-1. When the worship function is opened, the compass pointer device is used for pointing to the direction of Mecca (Kaaba) via the compass pointer 106-2, so that a worshipper finds out the direction of Mecca (Kaaba); and when the worship function is not opened in the compass pointer device, the compass pointer 106-2 only has a guide function and is used for guiding the current position. The time zone pointer device is used for indicating time zone information of the current position via the time zone pointer 106-3.

It should be noted that the clock pointer device includes an hour-hand pointer device and a minute-hand pointer device, and their structures are similar to those of the compass pointer device and the time zone pointer device.

It should be noted that the pointers bring convenience to reading of the middle-aged and the aged in poor sight relative to the display manner of a display screen.

Preferably, the quick multifunctional smart watch for worship timing and orientation provided by the embodiment of the present invention further includes at least one key 107 which is connected with the controller 101.

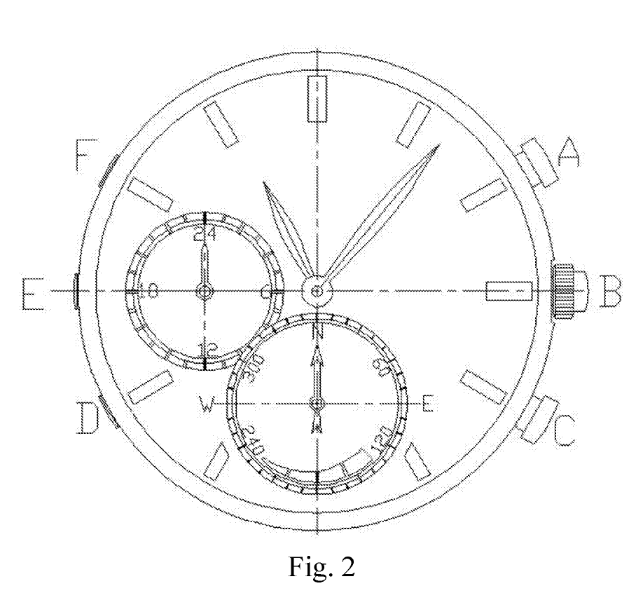

FIG. 2 is a structural diagram of a dial plate of the quick multifunctional smart watch for worship timing and orientation provided by an embodiment of the present invention. As shown in FIG. 2, keys 101 are distributed on the sides of the center dial plate. The embodiment of the present invention provides six keys 101 as an example as follows:

The keys 101 include key A, key B, key C, key D, key E and key F; the key A, key B, key C, key D, key E and key F are operated by a user, the key A, key C, key D and key F are operated for productive maintenance, user's quick operation of one key for one function is realized by multi-key hierarchical control, and user operation, productive adjustment and maintenance are hierarchically processed, so that the user can use various functions via quick and convenient operation.

It should be noted that quick operation of multi-key hierarchical one key for one function of the key A, key B, key C, key D, key E and key F is illustrated as follows:

(1) User Operation Layer

The key A is a time indication adjustment key, the key A is started by short press, the minute hand of the clock pointer 106-1 revolves to 12 o'clock, and the morning and the afternoon are synchronized to 24 hours of a time zone; the key B is pressed to adjust the time: one short press for one scale (1 degree) and long press for quick movement; the key A is pressed for a short time for acknowledging or automatic exit is realized by no operation within 60 seconds.

The key B is a start key, and the compass pointer 106-2 is started by pressing the key B for a short time, exits by pressing the key B again or automatically exits after working for 60 seconds; the energy of the power supply 107 is displayed by pressing the key B for a long time of 3 seconds, and the display exits after 5 seconds. The key C is a MECCA indication key, the key C is pressed for a short time to start the home search function, the compass pointer 106-2 swings at the zero position, receives GPS positioning signals and begins indicating the position of MECCA after 60 seconds, and the key C is pressed for a short time to exit from the home search function.

The key D is a worship time acknowledgment key, and the key D is pressed for a short time to start daily five worships; after starting, the minute hand of the clock pointer 106-1 swings at 1 o'clock (amplitude +/−10 degrees), the key B is pressed to adjust the 9 o'clock pointer to the first worship, the key B is pressed for a short time once for one scale (1 degree) and pressed for a long time for quick movement, and the key D is pressed for a short time for acknowledgment; after acknowledgment, the minute hand swings at 2 o'clock (amplitude +/−10 degrees), the key B is pressed to adjust the 9 o'clock pointer to the second worship, the key B is pressed for a short time once for one scale (1 degree) and pressed for a long time for quick movement, and the key D is pressed for a short time for acknowledgment; after acknowledgment, the minute hand swings at 3 o'clock (amplitude +/−10 degrees), the key B is pressed to adjust the 9 o'clock pointer to the third worship, the key B is pressed for a short time once for one scale (1 degree) and pressed for a long time for quick movement, and the key D is pressed for a short time for acknowledgment; after acknowledgment, the minute hand swings at 4 o'clock (amplitude +/−10 degrees), the key B is pressed to adjust the 9 o'clock pointer to the fourth worship, the key B is pressed for a short time once for one scale (1 degree) and pressed for a long time for quick movement, and the key D is pressed for a short time for acknowledgment; after acknowledgment, the minute hand swings at 5 o'clock (amplitude +/−10 degrees), the key B is pressed to adjust the 9 o'clock pointer to the fifth worship, the key B is pressed for a short time once for one scale (1 degree) and pressed for a long time for quick movement, and the key D is pressed for a short time for acknowledging and exiting from five-worship time setting. The 9 o'clock pointer returns to the original time zone for displaying. After setting and before 1 minute ahead of each worship, the minute hand swings at the time position for reminding, and the compass points to MECCA; the buzzer rings, and the compass points to MECCA; the worship direction is used after the MECCA position is acknowledged.

The key E is a MECCA acknowledgement key, and the key E is started by short press; the compass pointer 106-2 swings at 6 o'clock and receives a GPS positioning signal; after 60 seconds, when a positioning signal is received, the compass pointer 106-2 stops swinging at 6 o'clock and returns to zero; when no positioning signal is received, the compass pointer 106-2 continuously swings at 6 o'clock, exits by pressing the key E for a short time and returns to zero. (This function needs to be set after the customer purchases and replaces the battery).

The key F is a time zone setting key, and the key F is started by short press; the key B is pressed for adjusting: one short press for half an hour; and then the key E is pressed for acknowledging or automatic exit is realized by no operation within 60 seconds.

(2) Productive Maintenance Layer

The key A is a time indication adjustment key (zero adjustment of hour and minute hands), the key A is started by pressing it for a long time of 3 seconds, and the hour and minute hands automatically return to zero (non return to zero during power on); if the zero position is accurate, the key A is pressed for a short time for acknowledging; if the zero position is inaccurate, the key B is pressed for adjusting: one short press for one scale (1 degree) and long press for quick movement, and the key A is pressed for a short time for acknowledging (or automatically exits by no operation within 60 seconds).

The key C is a MECCA indication key, the key C is pressed for a long time of 3 seconds to start GPS time correction (dual time zone synchronization); the center minute hand swings at the zero position (12 o'clock) and receives GPS positioning signals; after 60 seconds, when a time correction signal is received, the pointer stops swinging at the zero position and indicates the corrected time; and when a time correction signal is not received, the pointer continues swinging at the zero position, and the key A is pressed for a short time to exit and return to the original time.

The key D is a MECCA acknowledgment key (compass zero adjustment), and the key D is started by pressing it for a long time of 3 seconds (the pointer revolves for one circle); the key B is pressed for adjusting: one short press for one scale (1 degree) and long press for quick movement; and the key D is pressed again for a short time for acknowledging or automatic exit is realized by no operation within 60 seconds.

The key F is a time zone setting key (zero adjustment of the time zone pointer), the key E is started by pressing it for a long time of 3 seconds, and the pointer automatically returns to zero (non return to zero during power on); if the zero position is accurate, the key E is pressed for a short time for acknowledging; if the zero position is inaccurate, the key B is pressed for adjusting: one short press for one scale (1 degree) and long press for quick movement, and the key E is pressed for a short time for acknowledging or automatic exist is realized by no operation within 60 seconds.

Preferably, the quick multifunctional smart watch for worship timing and orientation provided by the embodiment of the present invention further includes a power supply 108 and a power switch 109; both the power supply 108 and the power switch 109 are connected with the controller 101; and the power supply 108 is connected with the positioning module 102, the geomagnetic sensor 103 and the pointer devices via the power switch 109 respectively.

It should be noted that the power supply 108 is also connected with the motors 104 and the gearboxes 105 via the power switch 109 respectively, to supply power to the motors 104 and the gearboxes 105.

It should be noted that the power supply 108 supplies power to the positioning module 101, the geomagnetic sensor module 102, the motors 104 and the gearboxes 105 via the power switch 109, so that the purpose of saving power is fulfilled in a power-off state at ordinary time, the energy is saved and the power consumption is reduced.

It should be noted that the controller 101 is in a dormant state under the time running mode by software setting to further reduce the power consumption of the system.

The quick multifunctional smart watch for worship timing and orientation provided by the embodiment of the present invention further includes dial plates, as shown in FIG. 2, the embodiment of the present invention provides three dial plates as an example as follows:

The dial plates include a center dial plate and an auxiliary dial plate arranged on the center dial plate. The center dial plate is a clock dial plate provided with time scales, and the clock pointer 106-1 (hour hand and minute hand) indicates the time scales on the clock dial plate; the auxiliary dial plate arranged between the center of the clock dial plate and 6 o'clock is a compass dial plate, the compass dial plate is provided with direction scales, and the compass pointer 106-2 points to the direction or the direction of Mecca (Kaaba) on the compass dial plate; the auxiliary dial plate arranged between the center of the clock dial plate and 6 o'clock is a time zone dial plate, the time zone dial plate is provided with time zone scales, and the time zone pointer 106-3 indicates the time zone scales on the time zone dial plate.

It should be noted that the quantity of the motors 104 is at least one, so the quantity of the dial plates corresponding to the motors is at least one, and the dial plates are distributed between 3, 6, 9 or 12 o'clock and the center of the center dial plate; and the pointers are driven by the controller to indicate time, Mecca (Kaaba) direction, guide, time zone, energy and the like.

It should be noted that a watchband is arranged on the side of the center dial plate, so that the watch is convenient to carry.

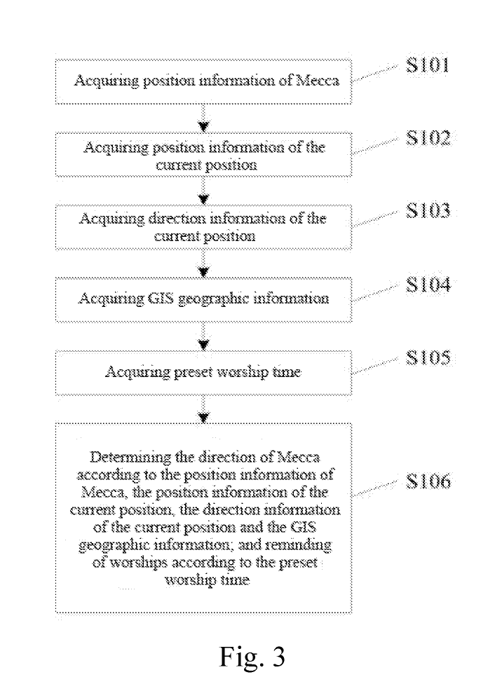

FIG. 3 is a flow diagram of a control method for the quick multifunctional smart watch for worship timing and orientation provided by an embodiment of the present invention. As shown in FIG. 3, the control method for the quick multifunctional smart watch for worship timing and orientation includes the following steps:

Step S101: acquiring position information of Mecca.

The position information of Mecca is pre-stored in the memory of the controller.

Step S102: acquiring position information of a current position.

It should be noted that in the present invention, the positioning module acquires the position information of the current position, and sends the acquired position information of the current position to the controller.

Step S103: acquiring direction information of the current position.

It should be noted that in the present invention, the geomagnetic sensor acquires the direction information of the current position (i.e., east, south, west and north direction information), and sends the acquired direction information of the current position to a processor.

Step S104: acquiring GIS geographic information.

It should be noted that the GIS geographic information is pre-stored in the memory of the controller.

Step S105: acquiring preset worship time.

It should be noted that the time of five worships is set according to sun rise and sunset of the place, and the worship time is pre-stored in the memory of the controller.

Step S106: determining the direction of Mecca according to the position information of Mecca, the position information of the current position, the direction information of the current position and the GIS geographic information; and reminding of worships according to the preset worship time.

It should be noted that the control method for the quick multifunctional smart watch for worship timing and orientation further includes: acquiring corrected direction information of the current position.

Step S106 of determining the direction of Mecca according to the position information of Mecca, the position information of the current position, the direction information of the current position and the GIS geographic information includes: determining a straight line between Mecca and the current position according to the position information of Mecca and the position information of the current position; determining the included angle between the straight line and the geographic axis, the included angle between the straight line and the geomagnetic axis and the included angle formed by the straight line and the corrected direction information of the current position according to the GIS geographic information; and determining the direction of the destination according to the included angle between the straight line and the geographic axis, the included angle between the straight line and the geomagnetic axis and the included angle formed by the straight line and the corrected direction information of the current position.

Based on a quick multifunctional smart watch for worship timing and orientation, the present invention can further realize a clock function, a compass function, a time zone function and the like, that is, multiple functions, modularization and customer personality of the smart watch are realized via the multi-pointer devices; the pointer display contents can be adjusted according to customer demands by adjusting application software and hardware, so that the watch has the functions of UTC time correction, dual time zone, automatic/manual energy display and time precision error automatic compensation; and Bluetooth, temperature sensor and infrared sensor module interfaces are reserved on the controller, so that the functions of the watch are richer. The clock control method, the compass control method and the time zone control method are specifically as follows:

Clock function: the controller controls the clock pointer device according to the position information of the current position to realize the clock function.

Compass function: the controller controls the compass pointer device according to the position information and the direction information of the current position to realize the compass function.

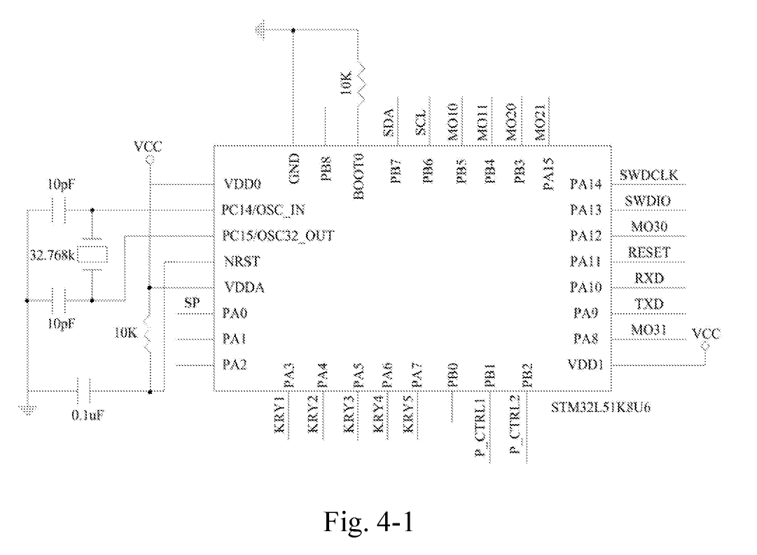

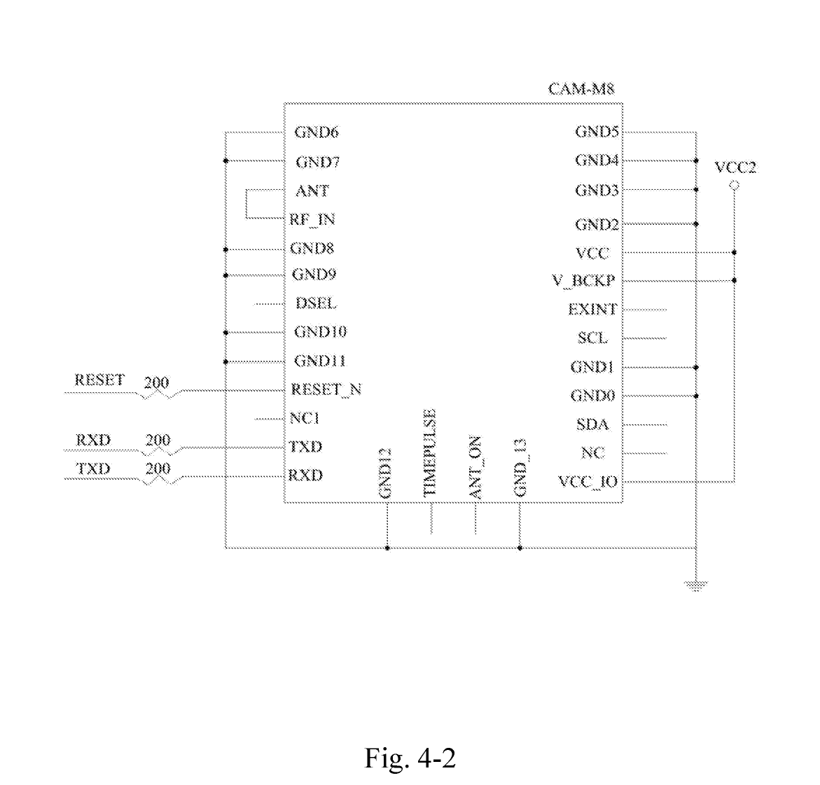

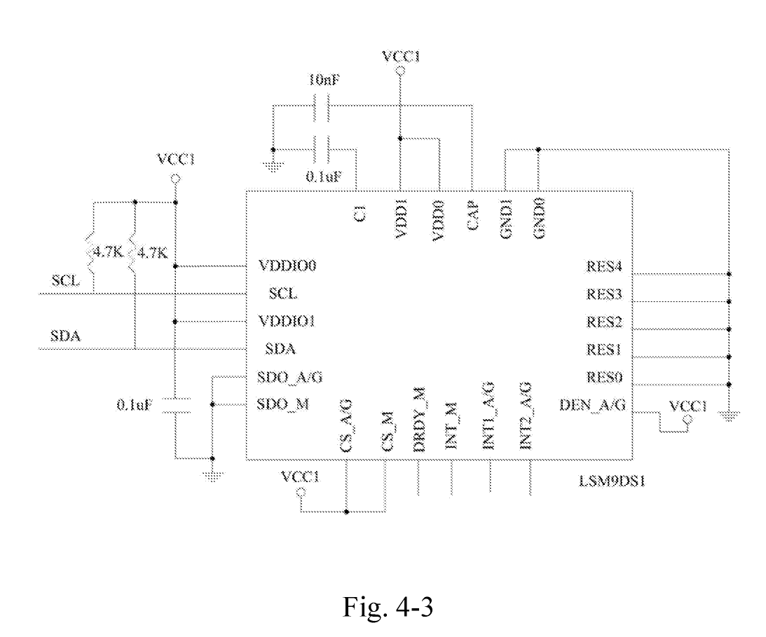

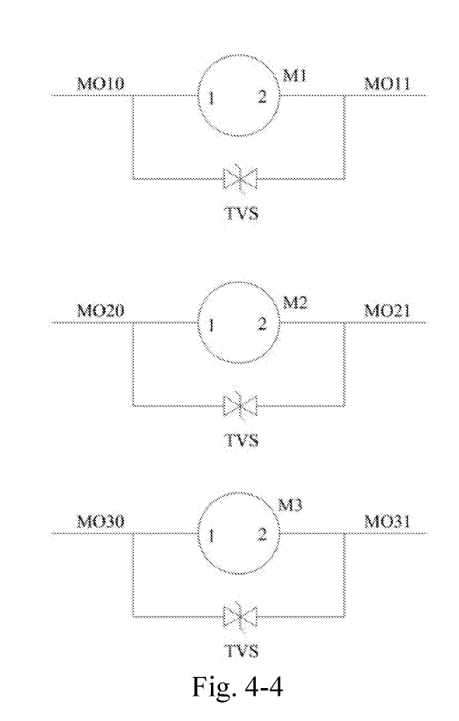

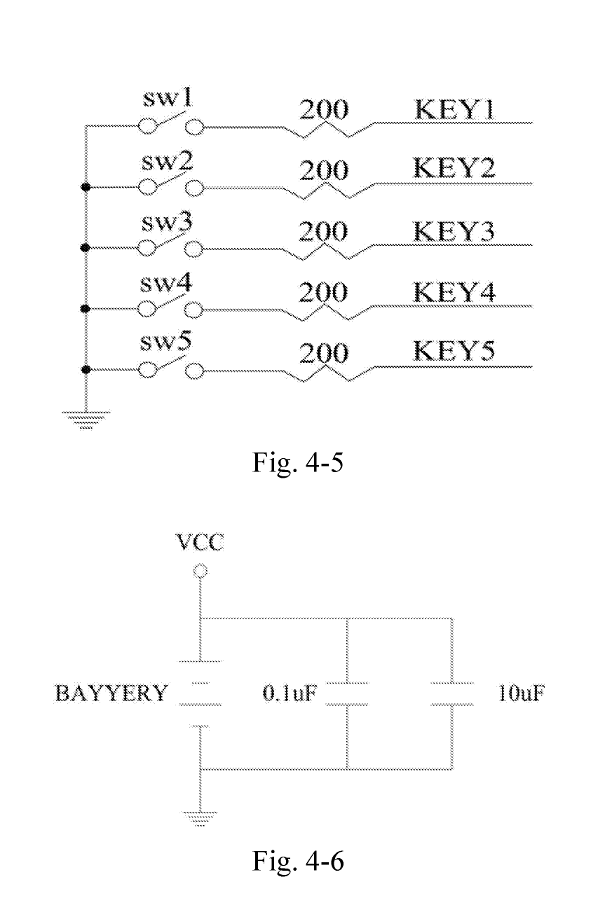

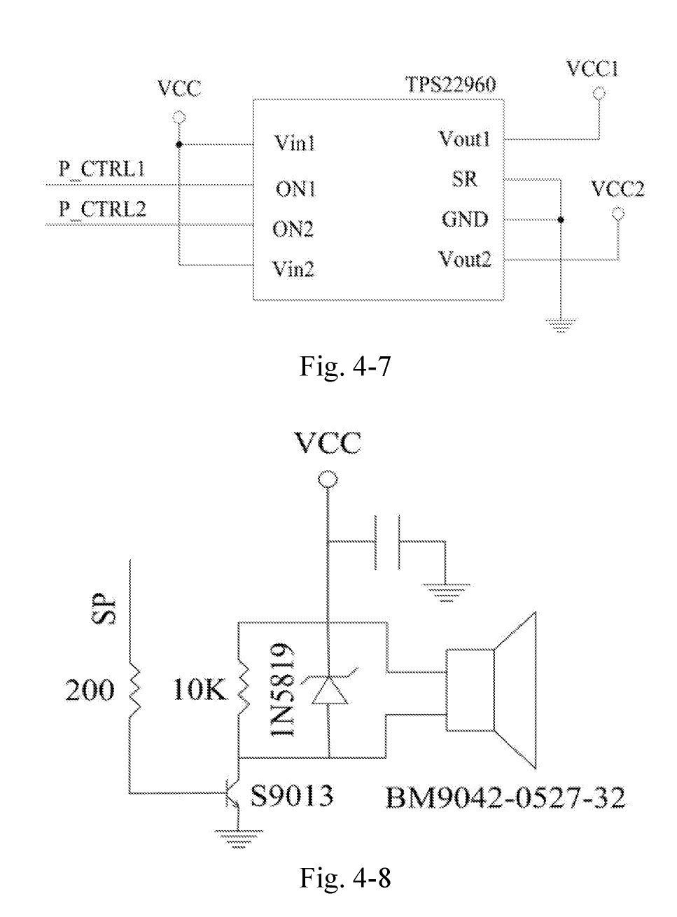

Time zone function: the controller controls the time zone pointer device according to the position information of the current position, the direction information of the current position and the GIS geographic information to realize the time zone function. FIG. 4-1 is a circuit principle diagram of the controller of the quick multifunctional smart watch for worship timing and orientation provided by an embodiment of the present invention. FIG. 4-2 is a circuit principle diagram of the positioning module of the quick multifunctional smart watch for worship timing and orientation provided by an embodiment of the present invention. FIG. 4-3 is a circuit principle diagram of the geomagnetic sensor of the quick multifunctional smart watch for worship timing and orientation provided by an embodiment of the present invention. FIG. 4-4 is a circuit principle diagram of motors of the quick multifunctional smart watch for worship timing and orientation provided by an embodiment of the present invention. FIG. 4-5 is a circuit principle diagram of keys of the quick multifunctional smart watch for worship timing and orientation provided by an embodiment of the present invention. FIG. 4-6 is a circuit principle diagram of the power supply of the quick multifunctional smart watch for worship timing and orientation provided by an embodiment of the present invention. FIG. 4-7 is a circuit principle diagram of the power switch of the quick multifunctional smart watch for worship timing and orientation provided by an embodiment of the present invention. FIG. 4-8 is a circuit principle diagram of the buzzer of the quick multifunctional smart watch for worship timing and orientation provided by an embodiment of the present invention. In combination with FIG. 1, FIG. 2, FIG. 3, FIG. 4-1, FIG. 4-2, FIG. 4-3, FIG. 4-4, FIG. 4-5, FIG. 4-6, FIG. 4-7 and FIG. 4-8, a specific circuit structure of the quick multifunctional smart watch for worship timing and orientation provided by the embodiment of the present invention includes: Device selection: the controller 101 is an STM32L51K8U6-type chip; the positioning module 102 is a CAM-M8 series positioning chip; the geomagnetic sensor 103 is an LSM9DS1-type nine-axis sensor module; the motors 104 are step motors; the power supply 108 is a 3V lithium battery, the power switch 109 is a TPS22960 module, and the buzzer 110 is a BM9042-0527-32-type buzzer.

The STM32L51K8U6 chip adopts a crystal oscillator of 32.768 kHZ.

Pins TXD, RXD and RESET_N in the CAM-M8 chip are respectively connected with pins PA10, PA9 and PA12 in the STM32L51K8U6 chip, wherein the pins PA10, PA9 and PA12 in the STM32L51K8U6 chip are respectively configured as pins RXD, TXD and RESET.

Pins SCL and SDA in the LSM9DS1 module are respectively connected with pins PB6 and PB7 in the STM32L51K8U6 chip, and are respectively connected with a 4.7K pull-up resistor, wherein the pins PB6 and PB7 in the STM32L51K8U6 chip are respectively configured as pins SCL and SDA.

The step motor M1 is connected in parallel with a TVS diode, and pins MO10 and MO11 of the TVS diode are respectively connected with pins PB5 and PB4 in the STM32L51K8U6 chip; the step motor M2 is connected in parallel with the TVS diode, and pins MO20 and MO21 of the TVS diode are respectively connected with pins PB3 and PA15 in the STM32L51K8U6 chip; the step motor M3 is connected in parallel with the TVS diode, and pins MO30 and MO31 of the TVS diode are respectively connected with pins PA12 and PA8 in the STM32L51K8U6 chip.

The keys SW1, SW2, SW3, SW4 and SW5 are respectively connected in series with a 200 ohm resistor and then connected with the pins PA3, PA4, PAS, PA6 and PA7 in the STM32L51K8U6 chip.

Two ends of the BATTERY are connected in parallel with a 0.1 UF capacitor and a 10 UF capacitor; the power end VCC of the BATTERY is connected with all power supply ends in the STM32L51K8U6 chip; the power end VCC of the BATTERY is connected with the input ends Vin1 and Vin2 of the TPS22960 module, and pins PB1 and PB2 in the STM32L51K8U6 chip are respectively connected with the control ends ON1 and ON2 of the TPS22960 module; and the output ends Vout1 and Vout2 of the TPS22960 module are respectively connected with the power supply end in the LSM9DS1 module and the power supply end in the CAM-M8 chip.

Two ends of the buzzer BM9042-0527-32 are connected in parallel with a voltage regulator tube 1N5819 and a 10K resistor, then connected in series with a triode S9013 and a 200 ohm resistor, and connected with the pin PAO in the STM32L51K8U6 chip.

In conclusion, the embodiments of the present invention provide a quick multifunctional smart watch for worship timing and orientation and a control method, wherein the controller in the watch acquires position information of the current position via the positioning module, acquires direction information of the current position via the geomagnetic sensor and controls the pointer devices to point to the direction of Mecca (Kaaba) via the positioning algorithm according to the position information of Mecca (Kaaba) and the GIS geographic information, so that a worshipper acquires the worship direction simply, intuitively and clearly via the pointers before worships, and the worships are automatically reminded according to the preset worship time.

Disclosed above are merely a few specific embodiments of the present invention, and various modifications and variations could be made to the present invention by those skilled in the art without departing from the spirit and scope of the present invention.

Provided that these modifications and variations made to the present invention are within the scope of the claims of the present invention and equivalent technologies thereof, the present invention is intended to cover these modifications and variations.

1. A quick multifunctional smart watch for worship timing and orientation, comprising a controller (101), a positioning module (102), a geomagnetic sensor (103) and pointer devices;
the positioning module (102) is used for acquiring position information of a current position and sending the position information of the current position to the controller (101);
the geomagnetic sensor (103) is used for acquiring direction information of the current position and sending the direction information of the current position to the controller (101);
the controller (101) is used for controlling the pointer devices to point to the direction of Mecca according to the position information of Mecca pre-stored in a memory of the controller (101), the position information of the current position, the direction information of the current position and the GIS (Geographic Information System) geographic information pre-stored in the memory of the controller (101); and the controller (101) is also used for reminding of worships according to the preset worship time pre-stored in the memory of the controller (101).

2. The quick multifunctional smart watch for worship timing and orientation of claim 1, wherein the watch further comprises a gyro, which is used for correcting the direction information of the current position to obtain corrected direction information of the current position;
the controller (101) is further used for determining a straight line between Mecca and the current position according to the position information of Mecca and the position information of the current position, determining the included angle between the straight line and the geographic axis, the included angle between the straight line and the geomagnetic axis and the included angle formed by the straight line and the corrected direction information of the current position according to the GIS geographic information, and controlling the pointer devices to point to the direction of Mecca according to the included angle between the straight line and the geographic axis, the included angle between the straight line and the geomagnetic axis and the included angle formed by the straight line and the corrected direction information of the current position.

3. The quick multifunctional smart watch for worship timing and orientation of claim 1, wherein the watch further comprises a buzzer (110), which is connected with the controller (101) and used for reminding of worships according to the preset worship time pre-stored in the memory of the controller (101).

4. The quick multifunctional smart watch for worship timing and orientation of claim 1, wherein the pointer devices comprise motors (104), gearboxes (105) and pointers (106); the controller (101) is electrically connected with the motors (104), and the motors (104) are connected with the pointers (106) via the gearboxes (105); the motors (104) are step motors, and a plurality of motors (104) are provided.

5. The quick multifunctional smart watch for worship timing and orientation of claim 4, wherein the motors (104) comprise a first motor (104-1), a second motor (104-2) and a third motor (104-3); the gearboxes (105) comprise a first gearbox (105-1), a second gearbox (105-2) and a third gearbox (105-3); the pointers (106) comprise a clock pointer (106-1), a compass pointer (106-2) and a time zone pointer (106-3);
the controller (101) is electrically connected with the first motor (104-1), the second motor (104-2) and the third motor (104-3) respectively;
the first motor (104-1) is connected with the clock pointer (106-1) via the first gearbox (105-1), the second motor (104-2) is connected with the compass pointer (106-2) via the second gearbox (105-2), and the third motor (104-3) is connected with the time zone pointer (106-3) via the third gearbox (105-3).

6. The quick multifunctional smart watch for worship timing and orientation of claim 1, wherein the watch further comprises a UTC module, a dual time zone functional module, an automatic/manual energy display module and a time precision error automatic compensation module, and the watch is further reserved with a Bluetooth interface, a temperature sensor interface and an infrared sensor interface.

7. The quick multifunctional smart watch for worship timing and orientation of claim 1, wherein the watch further comprises at least one key (107) which is connected with the controller (101).

8. The quick multifunctional smart watch for worship timing and orientation of claim 1, wherein the watch further comprises a power supply (108) and a power switch (109); both the power supply (108) and the power switch (109) are connected with the controller (101); and the power supply (108) is connected with the positioning module (102), the geomagnetic sensor (103) and the pointer devices via the power switch (109) respectively.

9. A control method for the quick multifunctional smart watch for worship timing and orientation, comprising the following steps:
acquiring position information of Mecca;
acquiring position information of the current position;
acquiring direction information of the current position;
acquiring GIS geographic information;
acquiring preset worship time;
determining the direction of Mecca according to the position information of Mecca, the position information of the current position, the direction information of the current position and the GIS geographic information; and reminding of worships according to the preset worship time.

10. The control method for the quick multifunctional smart watch for worship timing and orientation of claim 9, wherein the control method for the watch further comprises: acquiring corrected direction information of the current position;
the step of determining the direction of the destination according to the position information of Mecca, the position information of the current position, the direction information of the current position and the GIS geographic information comprises:
determining a straight line between Mecca and the current position according to the position information of Mecca and the position information of the current position;
determining the included angle between the straight line and the geographic axis, the included angle between the straight line and the geomagnetic axis and the included angle formed by the straight line and the corrected direction information of the current position according to the GIS geographic information; and
determining the direction of the destination according to the included angle between the straight line and the geographic axis, the included angle between the straight line and the geomagnetic axis and the included angle formed by the straight line and the corrected direction information of the current position.
